(19) United States
(12) Patent Application Publication
(10) Pub. No.: US 2024/0371046 A1
(43) Pub. Date: Nov. 7, 2024

(54) Point Cloud Attribute Encoding Method and Apparatus, and Point Cloud Attribute Decoding Method and Apparatus

(71) Applicant: PENG CHENG LABORATORY, Shenzhen (CN)

(72) Inventors: Yueru Chen, Shenzhen (CN); Jing Wang, Shenzhen (CN); Ge Li, Shenzhen (CN); Wen Gao, Shenzhen (CN)

(21) Appl. No.: 18/683,359

(22) PCT Filed: Aug. 23, 2022
(86) PCT No.: PCT/CN2022/114180

§ 371 Date: Feb. 13, 2024

(30) Foreign Application Priority Data
Aug. 23, 2021 (CN) 202110969710.5

(51) Int. Cl. G06T 9/00

(52) U.S. Cl. CPC G06T 9/001

(57) ABSTRACT

A point cloud attribute encoding method and apparatus, decoding method and apparatus are disclosed. The point cloud attribute encoding method includes: sorting point cloud data to be encoded to obtain sorted point cloud data; constructing a multilayer structure based on the sorted point cloud data and distances between the sorted point cloud data; obtaining an encoding mode corresponding to each of nodes in the multilayer structure. The encoding mode corresponding to each of the nodes is a direct encoding mode, a predictive encoding mode, or a transform encoding mode. The predictive encoding mode is to encode a node based on information of a neighboring node corresponding to the node. The transform encoding mode is to encode the node based on a transform matrix; and encoding point cloud attributes for each of the nodes based on the multilayer structure and the respective encoding mode.

### CROSS-REFERENCE TO RELATED APPLICATIONS

This application is the United States national phase of International Patent Application No. PCT/CN2022/114180 filed Aug. 23, 2022, and claims priority to Chinese Patent Application No. 202110969710.5 filed Aug. 23, 2021, the disclosures of which are hereby incorporated by reference in their entireties.

### BACKGROUND

### 1. Technical Field

The present disclosure relates to the technical field of point cloud data processing, and in particular relates to a point cloud attribute encoding method and apparatus, and a point cloud attribute decoding method and apparatus.

### 2. Technical Considerations

With the progress of science and technology, especially the rapid development of 3D scanning equipment, the application of 3D reconstruction technology is becoming more and more widespread, and the accuracy and resolution of the point cloud are getting higher and higher. The number of points in a frame of point cloud is generally in the million level, in which each point contains geometric information and attribute information such as color, reflectivity, etc., and the data volume is huge. Therefore, it is very important to compress, encode and decode the point cloud during the transmission or use of the point cloud data.

In the existing technology, point cloud attributes are usually encoded and decoded by means of a prediction method. Specifically, in the encoding process, each point is encoded sequentially in order, the attribute value of a point is predicted using the information of a point that has been encoded in the previous sequence, and the encoding of the point is completed based on the predicted value and the true attribute value. The problem of the existing technology is that the range of space utilization when using the method of prediction for prediction is small, which is not conducive to improving the encoding efficiency.

Therefore, there is room for improvement and development of the existing technology.

### SUMMARY

The main objective of the present disclosure is to provide a point cloud attribute encoding method and apparatus, a point cloud attribute decoding method and apparatus, aiming at solving the problem of the existing technology that the range of space utilization when using the method of prediction for prediction is small, which is not conducive to the improvement of the encoding efficiency.

In a first aspect, a non-limiting embodiment of the present disclosure provides a point cloud attribute encoding method comprising:
sorting point cloud data to be encoded to obtain sorted point cloud data, wherein the point cloud data to be encoded are point cloud data with attributes to be encoded;
constructing a multilayer structure based on the sorted point cloud data and distances between the sorted point cloud data;
obtaining an encoding mode corresponding to each of nodes in the multilayer structure, wherein the encoding mode corresponding to each of the nodes is a direct encoding mode, a predictive encoding mode, or a transform encoding mode, wherein the predictive encoding mode is to encode a node based on information of a neighboring node corresponding to the node, and wherein the transform encoding mode is to encode the node based on a transform matrix; and
encoding point cloud attributes for each of the nodes based on the multilayer structure and the respective encoding mode.

In non-limiting embodiments or aspects, the sorting point cloud data to be encoded to obtain sorted point cloud data comprises:
based on three-dimensional coordinates of each of the point cloud data to be encoded, arranging the point cloud data to be encoded into a one-dimensional order from a three-dimensional distribution according to a preset rule to obtain the sorted point cloud data.

In non-limiting embodiments or aspects, the constructing a multilayer structure based on the sorted point cloud data and distances between the sorted point cloud data comprises:
using the sorted point cloud data as nodes in a bottom layer; and
constructing the multilayer structure from bottom up based on the nodes in the bottom layer and distances between the nodes in the bottom layer, wherein a distance between a plurality of child nodes corresponding to a parent node of the multilayer structure is less than a preset distance threshold.

In non-limiting embodiments or aspects, the obtaining an encoding mode corresponding to each of nodes in the multilayer structure, wherein the encoding mode corresponding to each of the nodes is a direct encoding mode, a predictive encoding mode, or a transform encoding mode, comprises:
setting the encoding mode corresponding to direct encoding nodes in the multilayer structure to be the direct encoding mode, the direct encoding nodes being nodes in the first layer of the multilayer structure;
setting the encoding mode corresponding to predictive encoding nodes in the multilayer structure to be the predictive encoding mode, the predictive encoding nodes being nodes from a second layer to a layer m of the multilayer structure that do not have a parent node; and
setting the encoding method corresponding to transform encoding nodes in the multilayer structure to be the transform encoding mode, the transform encoding nodes being nodes from the second layer to the layer m of the multilayer structure that have a parent node;
wherein the multilayer structure comprises M layers, the layer m is a bottom layer.

In non-limiting embodiments or aspects, the direct encoding mode is to encode the direct encoding nodes directly based on information of the direct encoding nodes; the predictive encoding mode is to encode the predictive encoding nodes based on information of neighboring nodes within a proximity range of the respective predictive encoding nodes; and the transform encoding mode is to encode the transform encoding nodes using a transform matrix.

In non-limiting embodiments or aspects, the encoding point cloud attributes for each of the nodes based on the multilayer structure and the respective encoding mode comprises:
calculating a first attribute coefficient of each of the nodes based on the multilayer structure from bottom up, wherein the first attribute coefficient of a node in the bottom layer of the multilayer structure is a raw point cloud attribute value corresponding to the node, and the first attribute coefficients of nodes in other layers are DC coefficients corresponding to the respective nodes in the other layers; and
encoding each of the nodes from top to bottom based on the multilayer structure, the first attribute coefficient of each of the nodes, and the respective encoding mode of each of the nodes.

In non-limiting embodiments or aspects, the encoding each of the nodes from top to bottom based on the multilayer structure, the first attribute coefficient of each of the nodes, and the respective encoding mode of each of the nodes comprises:
traversing the multilayer structure from top to bottom from m=1 to m=M−1, to obtain second attribute coefficient and/or first attribute residual coefficient corresponding to each of the nodes by:
   taking nodes in a layer m as first target nodes, calculating the second attribute coefficients for each of the first target nodes and reconstructed first attribute coefficients of transform encoding mode child nodes of each of the first target nodes based on each of the first target nodes and the respective transform encoding mode child nodes; and
   for each of predictive encoding nodes in a layer m+1, obtaining a second target node corresponding to each of the predictive encoding nodes in the layer m+1 respectively, and obtaining by estimation the first attribute residual coefficients of the corresponding predictive encoding nodes;
   wherein the second attribute coefficient is an AC coefficient corresponding to each of the nodes, the second target node comprises K nodes in the layer m+1 that are closest to the respective predictive encoding node and have calculated the reconstructed first attribute coefficients, and K is a preset number of searches; and
performing quantization and entropy encoding for the first attribute coefficients of the nodes in the first layer of the multilayer structure and the second attribute coefficients and/or the first attribute residual coefficients of the nodes in the other layers.

In a second aspect, a non-limiting embodiment of the present disclosure provides a point cloud attribute encoding apparatus wherein the point cloud attribute encoding apparatus comprises:
a sorting module for sorting point cloud data to be encoded to obtain sorted point cloud data, wherein the point cloud data to be encoded are point cloud data with attributes to be encoded;
a multilayer structure construction module for constructing a multilayer structure based on the sorted point cloud data and distances between the sorted point cloud data;
an encoding mode acquisition module for obtaining an encoding mode corresponding to each of nodes in the multilayer structure, wherein the encoding mode corresponding to each of the nodes is a direct encoding mode, a predictive encoding mode, or a transform encoding mode, wherein the predictive encoding mode is to encode a node based on information of a neighboring node corresponding to the node, and wherein the transform encoding mode is to encode the node based on a transform matrix; and
an encoding module for encoding point cloud attributes for each of the nodes based on the multilayer structure and the respective encoding mode.

In a third aspect, a non-limiting embodiment of the present disclosure provides a point cloud attribute decoding method, comprising:
sorting point cloud data to be decoded to obtain sorted point cloud data to be decoded, the point cloud data to be decoded being point cloud data with attributes to be decoded;
constructing a multilayer structure based on the sorted point cloud data to be decoded and distances between the sorted point cloud data to be decoded;
obtaining a decoding mode corresponding to each of nodes in the multilayer structure, wherein the decoding mode corresponding to each of the nodes is a direct decoding mode, a predictive decoding mode, or a transform decoding mode, wherein the predictive decoding mode is to decode a node based on information of a neighboring node corresponding to the node, and the transform decoding mode is to decode the node based on a transform matrix; and
decoding point cloud attributes for each of the nodes based on the multilayer structure and the respective decoding mode.

In non-limiting embodiments or aspects, the sorting point cloud data to be decoded to obtain sorted point cloud data to be decoded, the point cloud data to be decoded being point cloud data with attributes to be decoded, comprises:
based on three-dimensional coordinates of each of the point cloud data to be decoded, arranging the point cloud data to be decoded into a one-dimensional order from a three-dimensional distribution according to a preset rule, to obtain the sorted point cloud data to be decoded.

In non-limiting embodiments or aspects, the constructing a multilayer structure based on the sorted point cloud data to be decoded and distances between the sorted point cloud data to be decoded comprises:
using the sorted point cloud data to be decoded as nodes in a bottom layer; and
constructing the multilayer structure from bottom up based on the nodes in the bottom layer and distances between the nodes in the bottom layer, wherein a distance between a plurality of child nodes corresponding to a parent node of the multilayer structure is less than a preset distance threshold.

In non-limiting embodiments or aspects, the decoding point cloud attributes for each of the nodes based on the multilayer structure and the respective decoding mode comprises:
calculating a reconstructed first attribute coefficient for each of the nodes from top to bottom based on the multilayer structure; and
decoding each of the nodes from top to bottom based on the multilayer structure, the reconstructed first attribute coefficient of each of the nodes, and the decoding mode corresponding to each of the nodes.

In a fourth aspect, a non-limiting embodiment of the present disclosure provides a point cloud attribute decoding apparatus, comprising:
a sorting module for sorting point cloud data to be decoded to obtain sorted point cloud data to be decoded, wherein the point cloud data to be decoded are point cloud data with attributes to be decoded;
a multilayer structure construction module for constructing a multilayer structure based on the sorted point cloud data to be decoded and distances between the sorted point cloud data to be decoded;
a decoding mode acquisition module for acquiring a decoding mode corresponding to each of nodes in the multilayer structure, wherein the decoding mode corresponding to each of the nodes is a direct decoding mode, a predictive decoding mode, or a transform decoding mode, wherein the predictive decoding mode is to decode a node based on information of a neighboring node corresponding to the node, and the transform decoding mode is to decode the node based on a transform matrix; and
a decoding module for decoding point cloud attributes for each of the nodes based on the multilayer structure and the respective decoding mode.

As can be seen from the above, in the point cloud attribute encoding method provided by an embodiment of the present disclosure, point cloud data to be encoded are sorted to obtain the sorted point cloud data, wherein the point cloud data to be encoded are point cloud data with attributes to be encoded; a multilayer structure is constructed based on the sorted point cloud data and distances between the sorted point cloud data; an encoding mode corresponding to each of nodes in the multilayer structure is obtained, wherein the encoding mode corresponding to each of the nodes is a direct encoding mode, a predictive encoding mode, or a transform encoding mode, wherein the predictive encoding mode is to encode a node based on information of a neighboring node corresponding to the node, and wherein the transform encoding mode is to encode the node based on a transform matrix; and point cloud attributes are encoded for each of the nodes based on the multilayer structure and the respective encoding mode. Compared with the existing technology, in the solution of the present disclosure, a multilayer structure is constructed based on the distances between sorted point cloud data and encoding is performed based on the multilayer structure, which is conducive to expanding the range of space utilization. Moreover, a suitable encoding mode is assigned to each node to further improve the encoding efficiency of each node, thereby improving the overall encoding efficiency of the point cloud data.

### BRIEF DESCRIPTION OF THE DRAWINGS

In order to more clearly illustrate the technical solutions in the embodiments of the present disclosure, the following will briefly introduce the accompanying drawings that need to be used in the description of the embodiments or existing technology, and it will be obvious that the accompanying drawings in the following description are only some embodiments of the present disclosure, and for a person of ordinary skill in the art, other accompanying drawings can be obtained based on these drawings without paying for the creative laboriousness.

FIG. 1 is a flowchart of a point cloud attribute encoding method provided by a non-limiting embodiment or aspect of the present disclosure;

FIG. 2 is a specific flowchart of step S200 in FIG. 1 according to a non-limiting embodiment or aspect of the present disclosure;

FIG. 3 is a specific flowchart of step S300 in FIG. 1 according to a non-limiting embodiment or aspect of the present disclosure;

FIG. 4 is a schematic diagram of a multilayer structure provided by a non-limiting embodiment or aspect of the present disclosure;

FIG. 5 is a schematic diagram of a multilayer structure provided by a non-limiting embodiment or aspect of the present disclosure;

FIG. 6 is a specific flowchart of step S400 in FIG. 1 according to a non-limiting embodiment or aspect of the present disclosure;

FIG. 7 is a flowchart of a point cloud attribute encoding method including an encoding residual processing step provided by a non-limiting embodiment or aspect of the present disclosure;

FIG. 8 is a schematic diagram of a structure of a point cloud attribute encoding apparatus provided by a non-limiting embodiment or aspect of the present disclosure;

FIG. 9 is a flowchart of a point cloud attribute decoding method provided by a non-limiting embodiment or aspect of the present disclosure;

FIG. 10 is a specific flowchart of step A200 in FIG. 9 according to a non-limiting embodiment or aspect of the present disclosure;

FIG. 11 is a specific flowchart of step A400 in FIG. 9 according to a non-limiting embodiment or aspect of the present disclosure;

FIG. 12 is a flowchart of a point cloud attribute decoding method including a decoding residual processing step provided by a non-limiting embodiment or aspect of the present disclosure; and

FIG. 13 is a schematic diagram of a structure of a point cloud attribute decoding apparatus provided by a non-limiting embodiment or aspect of the present disclosure.

### DETAILED DESCRIPTION

In the following description, specific details such as particular system structures, techniques, and the like are presented for purposes of illustration and not for purposes of limitation, in order to provide a thorough understanding of embodiments of the present disclosure. However, it should be clear to those of ordinary skills in the art that the present disclosure can be realized in other embodiments without these specific details. In other cases, detailed descriptions of well-known systems, apparatuses, circuits, and methods are omitted so that unnecessary details do not hinder the description of the present disclosure.

It should be understood that, when used in this specification and the appended claims, the term “including/comprising” indicates the presence of the described features, integrals, steps, operations, elements, and/or components, but does not preclude the presence or addition of one or more other features, integrals, steps, operations, elements, components, and/or collections thereof.

It should also be understood that the terms used in the specification of the present disclosure are used solely for the purpose of describing particular embodiments and are not intended to limit the present disclosure. As used in the specification of the present disclosure and the appended claims, the singular forms “one”, “a” and “the” are intended to include the plural form unless the context clearly indicates otherwise.

It should be further understood that the term “and/or” as used in the specification of the present disclosure and the appended claims refers to and includes any combination and possible combinations of one or more of the items listed in association.

As used in this specification and in the appended claims, the term “if” may be interpreted contextually as “when” or “once” or “in response to determining” or “in response to detecting”. Similarly, the phrases “if determined” or “if [the described condition or event] is detected” may be interpreted, depending on the context, to mean “once determined” or “in response to determining” or “once [the described condition or event] is detected” or “in response to detecting [the described condition or event]”.

The technical solutions in the embodiments of the present disclosure are hereinafter described clearly and completely in conjunction with the accompanying drawings of the embodiments of the present disclosure, and it is obvious that the described embodiments are only a part of the embodiments of the present disclosure and not of the embodiments. Based on the embodiments in the present disclosure, other embodiments obtained by a person of ordinary skill in the art without making creative labor fall within the scope of protection of the present disclosure.

Many specific details are set forth in the following description in order to facilitate a full understanding of the present disclosure, but the present disclosure may also be implemented in other ways different from those described herein, and those of ordinary skills in the art may similarly generalize without violating the connotations of the present disclosure, and thus the present disclosure is not limited by the specific embodiments disclosed below.

With the progress of science and technology, especially the rapid development of 3D scanning equipment, the application of 3D reconstruction technology is becoming more and more widespread, and the accuracy and resolution of the point cloud are getting higher and higher. The number of points in a frame of point cloud is generally in the million level, in which each point contains geometric information and attribute information such as color, reflectivity, etc., and the amount of data is huge. Therefore, it is very important to compress, encode and decode the point cloud during the transmission or use of the point cloud data.

In the existing technology, point cloud attributes are usually encoded and decoded by means of a prediction method. Specifically, in the encoding process, each point is encoded sequentially in order, the attribute value of a point is predicted using the information of a point that has been encoded in the previous sequence, and the encoding of the point is completed based on the predicted value and the true attribute value. The problem of the existing technology is that the range of space utilization when using the method of prediction for prediction is small, which is not conducive to improving the encoding efficiency.

With the progress of science and technology, especially the rapid development of 3D scanning equipment, the application of 3D reconstruction technology is becoming more and more widespread, and the accuracy and resolution of the point cloud are getting higher and higher. The number of points in a frame of point cloud is generally in the million level, in which each point contains geometric information and attribute information such as color, reflectivity, etc., and the amount of data is huge. Therefore, it is very important to compress, encode and decode the point cloud during the transmission or use of the point cloud data.

In the existing technology, the point cloud attributes are usually encoded and decoded by the prediction method. Specifically, during the encoding process, each point is encoded sequentially in order, the attribute value of a point is predicted using the information of the encoded point in the previous sequence, and the residual between the predicted value and the true attribute value is obtained, the residual is quantized to obtain the quantized residual coefficient, and the quantized residual coefficient is subjected to entropy encoding to complete the encoding of the point. On this basis, for the first point, a fixed value is used to represent the predicted value, for example, the color attribute is represented by R=128, G=128, B=128. The quantized residual coefficients are inversely quantized accordingly to obtain the reconstructed residuals, which are added to the predicted values to obtain the reconstructed attribute values, which are used for the prediction of the subsequence points. The problem of the existing technology is that the range of space utilization when using the method of prediction for prediction is small, which is not conducive to improving the encoding efficiency.

In order to solve the problem of the existing technology, the present disclosure provides a point cloud attribute encoding method, which, in a non-limiting embodiment or aspect of the present disclosure, comprises: sorting point cloud data to be encoded to obtain sorted point cloud data, wherein the point cloud data to be encoded are point cloud data with attributes to be encoded; constructing a multilayer structure based on the sorted point cloud data and distances between the sorted point cloud data; obtaining an encoding mode corresponding to each of nodes in the multilayer structure, wherein the encoding mode corresponding to each of the nodes is a direct encoding mode, a predictive encoding mode, or a transform encoding mode, wherein the predictive encoding mode is to encode a node based on information of a neighboring node corresponding to the node, and wherein the transform encoding mode is to encode the node based on a transform matrix; and encoding point cloud attributes for each of the nodes based on the multilayer structure and the respective encoding mode. Compared with the existing technology, in the solution of the present disclosure, a multilayer structure is constructed based on the distances between sorted point cloud data and encoding is performed based on the multilayer structure, which is conducive to expanding the range of space utilization. Moreover, a suitable encoding mode is assigned to each node to further improve the encoding efficiency of each node, thereby improving the overall encoding efficiency of the point cloud data.

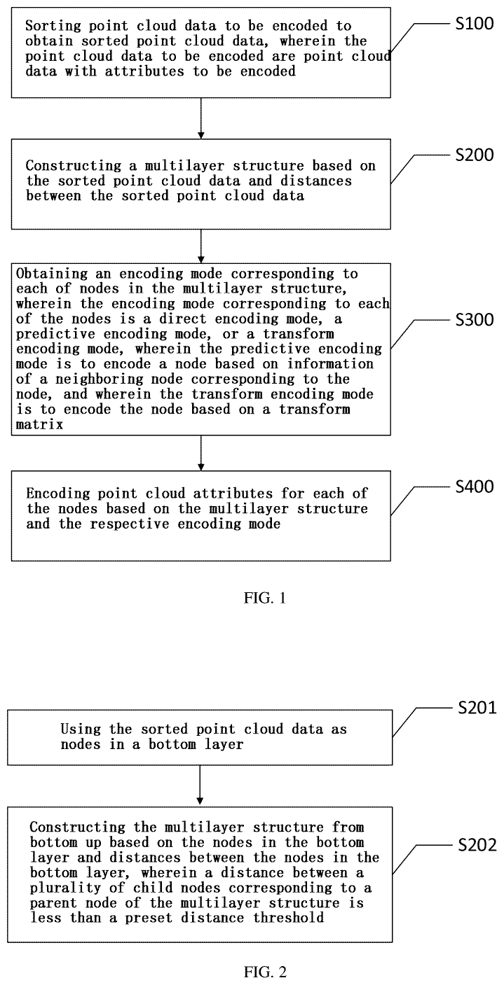

As shown in FIG. 1, non-limiting embodiments or aspects of the present disclosure provide a point cloud attribute encoding method, specifically, the method includes the following steps.

At step S100, point cloud data to be encoded are sorted to obtain the sorted point cloud data, wherein the point cloud data to be encoded are point cloud data with attributes to be encoded.

The point cloud data to be encoded are point cloud data with attributes to be encoded. The point cloud encoding mainly includes geometric encoding and attribute encoding, and the non-limiting embodiments or aspects of the present disclosure mainly implement point cloud attribute encoding, such as encoding the color attributes of the point cloud.

At step S200, a multilayer structure is constructed based on the sorted point cloud data and distances between the sorted point cloud data.

The multilayer structure is a multilayer structure comprising a plurality of nodes, for example, the multilayer structure is an M-layer structure (M is a positive integer), and the Layer m is the bottom layer, then the points corresponding to the point cloud data are taken as the nodes of the Layer m, respectively, and then based on the distances between the nodes of the Layer m, it is determined whether or not it has a parent node and the corresponding parent node is constructed, and so on, layer by layer, to construct the M-layer structure.

At step S300, an encoding mode corresponding to each of nodes in the multilayer structure is obtained, wherein the encoding mode corresponding to each of the nodes is a direct encoding mode, a predictive encoding mode, or a transform encoding mode, wherein the predictive encoding mode is to encode a node based on information of a neighboring node corresponding to the node, and wherein the transform encoding mode is to encode the node based on a transform matrix.

The corresponding node may be encoded in the predictive encoding mode based on an existing prediction method, and the corresponding node may be encoded in the transform encoding mode based on a Haar wavelet transform method. In the present disclosure, the corresponding node is encoded in the predictive encoding mode based on an improved prediction method incorporating a multilayer structure, without being specifically limited. The transform matrix is a pre-set transform matrix, which can be set and adjusted according to actual needs, without being specifically limited herein.

At step S400, point cloud attributes are encoded for each of the nodes based on the multilayer structure and the respective encoding mode.

Specifically, based on the multilayer structure and the respective encoding mode, the point cloud attribute data corresponding to each of the nodes are calculated, quantized and entropy encoded to complete the encoding task of the point cloud.

As can be seen from the above, in the point cloud attribute encoding method provided by a non-limiting embodiment or aspect of the present disclosure, point cloud data to be encoded are sorted to obtain the sorted point cloud data, wherein the point cloud data to be encoded are point cloud data with attributes to be encoded; a multilayer structure is constructed based on the sorted point cloud data and distances between the sorted point cloud data; an encoding mode corresponding to each of nodes in the multilayer structure is obtained, wherein the encoding mode corresponding to each of the nodes is a direct encoding mode, a predictive encoding mode, or a transform encoding mode, wherein the predictive encoding mode is to encode a node based on information of a neighboring node corresponding to the node, and wherein the transform encoding mode is to encode the node based on a transform matrix; and point cloud attributes are encoded for each of the nodes based on the multilayer structure and the respective encoding mode. Compared with the existing technology, in the solution of the present disclosure, a multilayer structure is constructed based on the distances between sorted point cloud data and encoding is performed based on the multilayer structure, which is conducive to expanding the range of space utilization. Moreover, a suitable encoding mode is assigned to each node to further improve the encoding efficiency of each node, thereby improving the overall encoding efficiency of the point cloud data.

Specifically, in this non-limiting embodiment or aspect, the step S100 comprises: based on three-dimensional coordinates of each of the point cloud data to be encoded, arranging of the point cloud data to be encoded into a one-dimensional order from a three-dimensional distribution according to a preset rule to obtain the sorted point cloud data. The preset rule is a pre-set sorting rule, which may be set and adjusted according to actual needs. Optionally, the preset rule may be a sorting rule based on a Morton code or a Hilbert code. Specifically, in this non-limiting embodiment or aspect, a target code corresponding to each of the point cloud data to be encoded is obtained based on the three-dimensional coordinates of each of the point cloud data to be encoded, wherein the target code is a Morton code or a Hilbert code; and the point cloud data to be encoded are sorted based on of the target codes, to obtained the sorted point cloud data. In this non-limiting embodiment or aspect, it is assumed that the point cloud comprises N points (i.e., corresponding to N to-be-encoded point cloud data), which are sorted based on the preset rule, with serial numbers from 1 to N, respectively.

Specifically, in this non-limiting embodiment or aspect, as shown in FIG. 2, the step S200 comprises the following steps.

At step S201, all the sorted point cloud data are used as nodes in a bottom layer.

At step S202, the multilayer structure is constructed from bottom up based on the nodes in the bottom layer and distances between the nodes in the bottom layer, wherein a distance between a plurality of child nodes corresponding to a parent node in the multilayer structure is less than a preset distance threshold.

The preset distance threshold is a preset value for limiting the distance relationship between the nodes, which may be set and adjusted according to the actual needs. Preferably, the distance threshold value is denoted by thₘ, which is related to the density of the points. For example, for the Layer m, let the average edge length of a point cloud enclosing box (the enclosing box is the smallest cuboid that can enclose the point cloud) be dmean, the number of nodes in the layer m is Nₘ and an adjustable parameter is s, then thₘ=\sqrt{s×dₘₑₐₙ×dₘₑₐₙ÷Nₘ}. s is a parameter that may be pre-set and adjusted according to the actual demand. s can be used to regulate the number of generated parent nodes, and the larger s is, the more parent nodes will be obtained. In an application scenario where one parent node corresponds to two child nodes (i.e., two child nodes are merged into one parent node), when the number of parent nodes Nₘ is small, nodes can be made to parent nodes in pairs, except for the last node in the case where Nₘ is an odd number. From the perspective of encoding efficiency (i.e., the final compressed data size), different point clouds correspond to different values of the optimal thₘ. From the perspective of time complexity, the larger thₘ, the smaller the computation and the less time.

In one application scenario, N points are used as nodes in the lowest layer (the Mth layer, i.e., the bottom layer). It is assumed that the current target point is i. The distances from subsequent P points to point i are calculated, and the distances are compared to find the largest integer p that satisfies that the distances between every two points i, i+1, . . . , i+p are less than thₘ. If p is greater than 0, points i, i+1, . . . , i+p are merged to form their parent node in layer M−1. It is assumed that point i+p+1 is the next target point, and the above steps are repeated. If p is equal to 0, point i is not merged with any point to generate a parent node, and point i+1 is set as the next target point to repeat the above steps. All points in layer M are traversed. P is a set integer greater than or equal to 1, which is used to limit the search range, and may be set and adjusted according to the actual demand, and will not be specifically limited here. For the nodes in layer M−1, merge them according to the above steps to form the nodes in layer M−2. Similarly, this process is repeated for layers of nodes until no nodes are merged within a layer, and the layer is taken as the first layer to form the M-layer structure.

In this non-limiting embodiment or aspect, it is preferably that a parent node is constructed from two child nodes, i.e., p is fixed to 1. Specifically, the N points are used as nodes in the bottom layer (layer M), and the distance di between the current point i and the next point i+1 is calculated. if di<thₘ, point i and point i+1 are merged to form their parent node in the layer M−1. These parent nodes constitute the nodes in the layer M−1 and are listed in the order of merging. After point i and point i+1 are merged, the next judgment is made for points i+2 and i+3, and if i and i+1 fail to merge, then the next judgment is made for points i+1 and i+2. For nodes in the layer M−1, they are merged according to the above steps, to constitute nodes in layer M−2. Similarly, this process is repeated for layers of nodes until no nodes are merged within a layer. In this way, a M-layer structure is obtained in from bottom up, based on which hierarchical transformation and prediction can be performed to realize point cloud encoding. Specifically, each node in the M-layer structure is assigned its position coordinates. For the nodes in the Layer m, the position of each point is the position of the corresponding geometric point in the point cloud. For the nodes in the other layers, the position of each point is determined according to the position of its child node. For example, the position coordinates of the middle point of the line connecting two child nodes are taken as the position coordinates of that parent node. Specifically, the point cloud attribute data of the parent node may also be determined based on the child nodes, for example, the average value of the color attributes of the child nodes is taken as the value of the color attribute of the parent node, and the color attribute of each node in the Layer m is the actual value of the color attribute of the corresponding point in the point cloud. Other setting methods are also possible, which are not specifically limited herein.

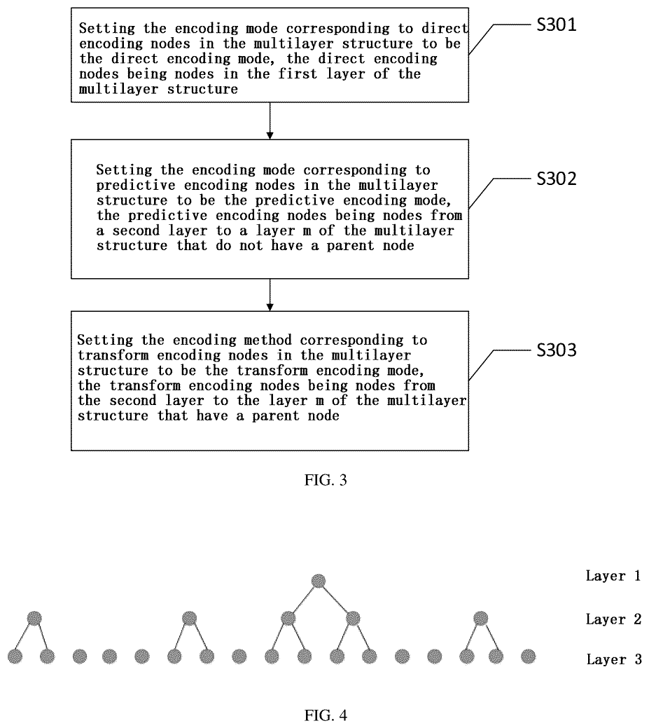

Specifically, in this non-limiting embodiment or aspect, as shown in FIG. 3, the step S300 comprises the following steps.

At step S301, the encoding mode corresponding to direct encoding nodes in the multilayer structure is set to be the direct encoding mode, and the direct encoding nodes are nodes in the first layer of the multilayer structure.

At step S302, the encoding mode corresponding to predictive encoding nodes in the multilayer structure is set to be the predictive encoding mode, and the predictive encoding nodes are nodes that do not have a parent node from the second layer to the Layer m of the multilayer structure.

At step S303, the encoding mode corresponding to transform encoding nodes in the multilayer structure is set to be the transform encoding mode, and the transform encoding nodes are nodes from the second layer to the Layer m of the multilayer structure that have a parent node.

The multilayer structure comprises M layers, and the Layer m is the bottom layer. FIG. 4 is a schematic diagram of a multilayer structure provided by a non-limiting embodiment or aspect of the present disclosure, specifically, M=3, i.e., a 3-layer structure is shown in FIG. 4. In FIG. 4, the node in the 1st layer is a direct encoding node, the points in the 2nd and 3rd layers that do not have a parent node are predictive encoding nodes, and the points in the 2nd and 3rd layers that have a parent node are transform encoding nodes.

Specifically, in this non-limiting embodiment or aspect, the direct encoding mode is to encode the direct encoding node directly based on the information of the direct encoding node; the predictive encoding mode is to encode the predictive encoding node based on the information of neighboring nodes within a proximity range of the predictive encoding node; and the transform encoding mode is to encode the transform encoding nodes using a transform matrix.

The proximity range is a pre-set range that may be set and adjusted according to the actual needs. In one application scenario, the proximity range may be a range that includes nodes in the layer. A neighboring node is a point in the proximity range whose distance from the predictive encoding node is less than thₘ.

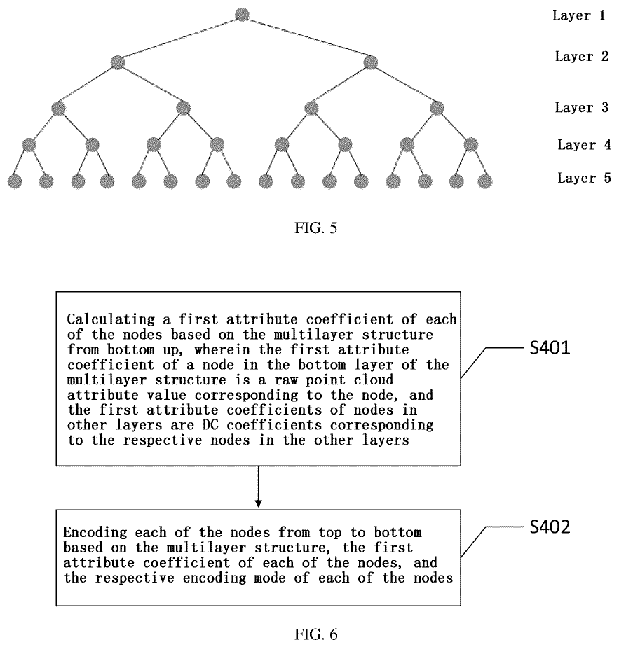

In one application scenario, the point cloud attribute encoding is specifically based on the Haar wavelet transform in the transform encoding mode. FIG. 5 is a schematic diagram of a multilayer structure provided by a non-limiting embodiment or aspect of the present disclosure, specifically, a 5-layer binary tree structure is shown in FIG. 5, i.e., M=5. For each node of the tree, a first attribute coefficient and a second attribute coefficient are defined, and certain nodes may have no second attribute coefficient. For example, a node in layer M has only a first attribute coefficient, and the first attribute coefficient of a node in layer M is the attribute value of the corresponding point cloud to be encoded (i.e., the raw attribute value). While the first attribute coefficient of each node in layers 1 through M−1 is the direct current coefficient (DC coefficient) of the transform output, the second attribute coefficient is the alternating current coefficient (AC coefficient) of the transform output. The transformation is performed from layer M−1 of the M-layer binary tree to the 1st layer. For the layer m of the binary tree, m=1, 2, . . . , M−1, the transformation is performed for each target node: if the target node has two child nodes, the transform matrix is

$${T}_{1} = \frac{1}{\sqrt{2}} ( \begin{matrix}1 & 1 \\ 1 & - 1\end{matrix} ) ,$$

the first attribute coefficients a1 and a2 of the two child nodes are transformed to obtain the first attribute coefficient and the second attribute coefficient of the target node, where the first attribute coefficient is (a1+a2)/\sqrt{2} and the second attribute coefficient is (a1−a2)/\sqrt{2}; if the target node has only one child node, the target node has only the first attribute coefficient and no second attribute coefficient, and its first attribute coefficient is equal to the first attribute coefficient of its child node multiplied by \sqrt{2}. After performing the transformations for layers, the obtained second attribute coefficients and the first attribute coefficients of the root node (i.e., the node in layer 1) are quantized and entropy encoded to complete the encoding task of the point cloud.

Specifically, the simple prediction method focuses on estimating the attribute value of the point to be encoded by utilizing the attribute information and geometric information of the encoded points in the vicinity of the point to be encoded, e.g., a weighted average is calculated based on the attribute values of three encoded points closest to the point to be encoded, which is used as the predicted attribute value of the point to be encoded. The more accurate the estimation, the higher the encoding efficiency. The accuracy of the estimation depends on whether the encoded points with high correlation with the attributes of the point to be encoded can be found. The attribute information value is used to reconstruct the attribute value, and the attribute may be the RGB value of the color. The geometric information refers to the position coordinates of a point, or specifically the distance from the encoded point to the point to be encoded. Encoding efficiency refers to the size of the compressed data finally output by the entropy encoder, the smaller the final compressed data, the higher more the encoding (compression) efficiency. It can be understood that if each predicted value is the same as the true value, then the residuals of the encoding are 0, and the compressed data is very small. The Haar wavelet transform method utilizes the idea of multilayer multi-resolution processing, which helps to utilize a wider range of point information, and the higher the correlation of the attributes of the group of transformed points, the higher the encoding efficiency. It should be noted that the multilayer process may also be referred to as multi-resolution processing, where the first attribute coefficients (DC coefficients) of each layer correspond to one resolution. The highest resolution is found in layer M, and the resolution decreases layer by layer after that.

In non-limiting embodiments or aspects of the present disclosure, based on the predictive encoding mode and the transform encoding mode, the simple prediction method and the Haar wavelet transform method described above are improved and used in combination. Based on the structure of multilayer processing, within each layer, through the known information such as the distance (the distance information is specifically utilized in a non-limiting embodiment or aspect, and it can be extended to utilize the reconstructed first attribute coefficient information, etc.), it is judged that the target node is subjected to the predictive encoding mode or transform encoding mode. This makes it possible to utilize the information of a wider range of points as well as to utilize the information of neighboring points more efficiently. For example, when two points are close, it may be considered that their attribute correlation is high, and the transform encoding mode is better (compared with the predictive encoding mode, the transform encoding mode has lower computational complexity); when two points are far apart, the predictive encoding mode may be used to more efficiently utilize the information of the neighboring points (compared with the simple prediction method, the predictive encoding mode of the present disclosure can find more neighboring points to obtain more accurate attribute prediction values). This improves the compression (encoding) efficiency, makes the final compressed data occupy less storage space, and also makes the compression time shorter and improves the encoding speed.

In this non-limiting embodiment or aspect, entropy encoding is used, and no information is lost in the encoding process according to the entropy principle, and a string of codes corresponding to each point (i.e., compressed data after entropy encoding) are finally obtained after encoding the point cloud, which are calculated from the point cloud attributes, and can be recovered by decoding, and the recovered point cloud is called reconstructed point cloud. The data before entropy encoding and after entropy decoding are identical without error. The error between the reconstructed point cloud attribute values and the original point cloud attribute values comes from the previous computational process (e.g., quantization process).

Specifically, in this non-limiting embodiment or aspect, as shown in FIG. 6, the step S400 comprises the following steps.

At step S401, a first attribute coefficient of each node is calculated based on the multilayer structure from bottom up, wherein the first attribute coefficient of a node in the bottom layer of the multilayer structure is a raw point cloud attribute value corresponding to the node, and the first attribute coefficients of nodes in other layers are DC coefficients corresponding to the nodes respectively.

At step S402, each node is encoded from top to bottom based on the multilayer structure, the first attribute coefficient of each node, and the respective encoding mode of each node.

Specifically, the step S402 comprises: traversing the multilayer structure from top to bottom from m=1 to m=M−1, to obtain the second attribute coefficient and/or the first attribute residual coefficient corresponding to each node by: taking nodes in a layer m as first target nodes, calculating the second attribute coefficients for each of the first target nodes and reconstructed first attribute coefficients of transform encoding mode child nodes of each of the first target nodes based on each of the first target nodes and the respective transform encoding mode child nodes; for each of predictive encoding nodes in a layer m+1, obtaining a second target node corresponding to each of the predictive encoding nodes in the layer m+1 respectively, and obtaining by estimation the first attribute residual coefficients of the corresponding predictive encoding nodes; wherein the second attribute coefficient is an AC coefficient corresponding to each of the nodes, the second target node comprises K nodes in the layer m+1 that are closest to the respective predictive encoding node and have calculated the reconstructed first attribute coefficients, and K is a preset number of searches; and performing quantization and entropy encoding for the first attribute coefficients of the nodes in the first layer of the multilayer structure and the second attribute coefficients and/or the first attribute residual coefficients of the nodes in the other layers.

Furthermore, in this non-limiting embodiment or aspect, the step S402 further comprises: sequentially quantizing and inversely quantizing the first attribute coefficients of each of the direct encoding nodes to obtain reconstructed first attribute coefficients of each of the direct encoding nodes; calculating reconstructed second attribute coefficients of each of the first target nodes based on each of the first target nodes and its corresponding transform encoding mode child node, respectively; and obtaining a first attribute prediction value, a reconstructed first attribute residual coefficient, and estimating a reconstructed first attribute coefficient of the corresponding predictive encoding node based on the second target node, so as to carry out corresponding decoding of the encoded data.

Specifically, in this non-limiting embodiment or aspect, the first attribute coefficients of the nodes are calculated from bottom up based on the M-layer structure. For the N nodes of the Mth layer (N is the number of points in the point cloud, which is the same as the number of points in the point cloud data to be encoded), their corresponding original point cloud attribute values (which may be specifically the values of attribute information such as color, reflectance, and so on) are taken as the first attribute coefficients. For the nodes in the layer M−1, it is assumed that the first attribute coefficients of their corresponding two child nodes are a1 and a2, respectively, and the transformed DC coefficients of the two child nodes are taken as their first attribute coefficients, i.e., (a1+a2)/\sqrt{2}. Based on the above steps, the first attribute coefficients of the nodes in each layer are calculated separately. This process stops at the first layer. As a result, each node in each layer has a first attribute coefficient.

Based on the M-layer structure, the reconstructed first attribute coefficients, the second attribute coefficients and the first attribute residual coefficients of the nodes are calculated from top to bottom. The specific steps are shown below:
a. The first attribute coefficient of the jth node in the first layer is directly encoded, and quantized and inversely quantized to obtain the reconstructed first attribute coefficient. In this way, encoding and decoding unity can be ensured. In the process of decoding, only the reconstructed xx coefficients (e.g., reconstructed first attribute coefficients) can be obtained, so the reconstructed xx coefficients of xx coefficients are calculated in the process of encoding, so as to ensure encoding and decoding unity. the reconstructed xx coefficients will have errors present compared to the xx coefficients, and the errors include quantization errors and inverse transformation accuracy errors.
b. For the jth node in the layer m, it is assumed that the first attribute coefficients of its corresponding transform encoding mode child nodes are a1 and a2, and the transformed AC coefficients of the two child nodes are used as its second attribute coefficient, i.e., (a1−a2)/\sqrt{2}. The second attribute coefficient is quantized and inversely quantized to obtain the reconstructed second attribute coefficient, which is inversely transformed together with the reconstructed first attribute coefficient of the jth node to obtain the reconstructed first attribute coefficients of the corresponding two child nodes. Similarly, all nodes of the m-layer are traversed. It is assumed that the reconstructed first attribute coefficients of the two child nodes are a1′ and a2′ and the reconstructed first attribute coefficient of the jth node is b1′ and the reconstructed second attribute coefficient of the jth node is b2′, then a1′=(b1′+b2′)/\sqrt{2}, a2′=(b1′−b2′)/\sqrt{2}.
c. For the jth predictive encoding mode node in the layer m+1, if it has no parent node, then its K (pre-set or adjusted by the user, generally K=3) nearest nodes within the layer that have already calculated the reconstructed first attribute coefficients (these nodes include: nodes with a parent node that have had their reconstructed first attribute coefficients calculated in the calculation of the layer m in step b; nodes without a parent node, but sorted before the jth node, and their reconstructed first attribute coefficients have been calculated in step c) are searched for. These nearest nodes are used to reconstruct the first attribute coefficient, and estimate the first attribute prediction value of the jth node (i.e., using the predictive encoding mode, the estimation method is the same as the prediction algorithm, e.g., the weighted average reconstruction attribute value of these K points is used as the prediction value of the jth node). The difference between the first attribute coefficient and the first attribute prediction value of the jth node is calculated and taken as the first attribute residual coefficient. The first attribute residual coefficient is quantized and inversely quantized to obtain the reconstructed first attribute residual coefficient, which is added with the first attribute prediction value of the jth node to obtain the reconstructed first attribute coefficient of the jth node. In this way, nodes in the layer m+1 are traversed and calculated.

Each layer of the M-layer structure for m=1, 2, . . . , M−2, M−1 is traversed from top to bottom, and the relevant calculations in the steps b and c are performed iteratively.

Specifically, referring to FIG. 4, the step a is performed for the nodes in the first layer of FIG. 4 to obtain the reconstructed first attribute coefficients for nodes in the first layer. The step b is performed for nodes in the first layer, so that the reconstructed first attribute coefficients for nodes in the second layer that have a parent node are obtained. The step c is performed for the nodes in the second layer that do not have a parent, so that the reconstructed first attribute coefficients for nodes in the second layer that do not have a parent node are obtained. The step b is performed for nodes of the second layer, and the step c is performed for nodes of the third layer that do not have a parent node. This process is repeated until the step b is performed for nodes of the layer M−1, and the step c is performed for nodes of the Layer m that do not have a parent node. The first attribute coefficients of the nodes of the first layer, which will not be transformed, will be directly entropy encoded, i.e., using the direct encoding mode.

After completing the transformations for layers, quantization and entropy encoding are performed based on the first attribute coefficients of nodes in the first layer and the second attribute coefficients and/or the first attribute residual coefficients of nodes in the other layers to complete the point cloud encoding task. At the same time, the reconstructed first attribute coefficients of the Layer m obtained by the calculation are used as the reconstructed attribute values of the original point cloud to obtain the reconstructed point cloud. For a node in a layer other than the first layer, if it has both the second attribute coefficient and the first attribute residual coefficient, both coefficients are encoded, and if it has only the second attribute coefficient and no first attribute residual coefficient, only the second attribute coefficient is encoded. The final set of coefficients for quantization and entropy encoding includes first attribute coefficients of the first layer, second attribute coefficients and/or first attribute residual coefficients of the layer m (m=1, 2, . . . , M−1).

It is to be noted that in this non-limiting embodiment or aspect the transformation and the inverse transformation may be carried out in the following manner. It is assumed that a signal within a transform encoding mode node (the signal refers to the first attribute coefficients a1 and a2 of two child nodes) is a row vector F∈R² (the first attribute coefficients corresponding to the two child nodes). R² indicates that each dimension of the two-dimensional vector (a1, a2) is a real number, and the transformed coefficients are a row vector C∈R² and the transform matrix is constructed as

$$A = \frac{1}{\sqrt{2}} ( \begin{matrix}1 & 1 \\ 1 & - 1\end{matrix} ) .$$

The Haar transform and the inverse Haar transform may be expressed as:

$$C = F \times A \qquad Haar transform$$

$$F = C \times {A}^{T} \qquad inverse Haar transform$$

For the Haar transformation process, it is assumed that the input coefficients are a1, a2 and the output coefficients be b1, b2, then b1=(a1+a2)/\sqrt{2}, b2=(a1−a2)/\sqrt{2}. For the inverse Haar transform process, it is assumed that the input coefficients are b1′, b2′ and the output coefficients are a1′, a2′, then a1′=(b1′+b2′)/\sqrt{2}, a2′=(b1′−b2′)/\sqrt{2}.

In this way, compared with the simple prediction algorithm, a multilayer processing method is used in non-limiting embodiments or aspects of the present disclosure, which expands the range of space utilization. Meanwhile, in the predictive encoding mode of the present disclosure, the information of the subsequent reconstructed points that have already been transformed by the parent node can be utilized to realize more accurate attribute prediction. Compared with the simple multilayer transformation algorithm, non-limiting embodiments or aspects of the present disclosure can effectively screen out the group with high transformation efficiency for transformation, and for the nodes with low transformation efficiency, the predictive encoding mode is used to further utilize the information of neighboring points to help encoding. In this way, the encoding efficiency can be improved. Specifically, encoding efficiency=compressed file size/original file size, the smaller the value of encoding efficiency, the higher the corresponding encoding efficiency. The present disclosure can improve the overall compression efficiency (i.e., encoding efficiency).

Further, since the transform method generally fails to realize lossless attribute encoding and decoding, the encoding residual processing step and the decoding residual processing step are provided in this non-limiting embodiment or aspect to realize lossless or limited-lossy attribute encoding and decoding, so as to improve the accuracy in the encoding and decoding process. Optionally, the encoding residual processing step and the decoding residual processing step may also be combined with other compression methods to realize lossless and limited-lossy attribute compression, and are not specifically limited herein.

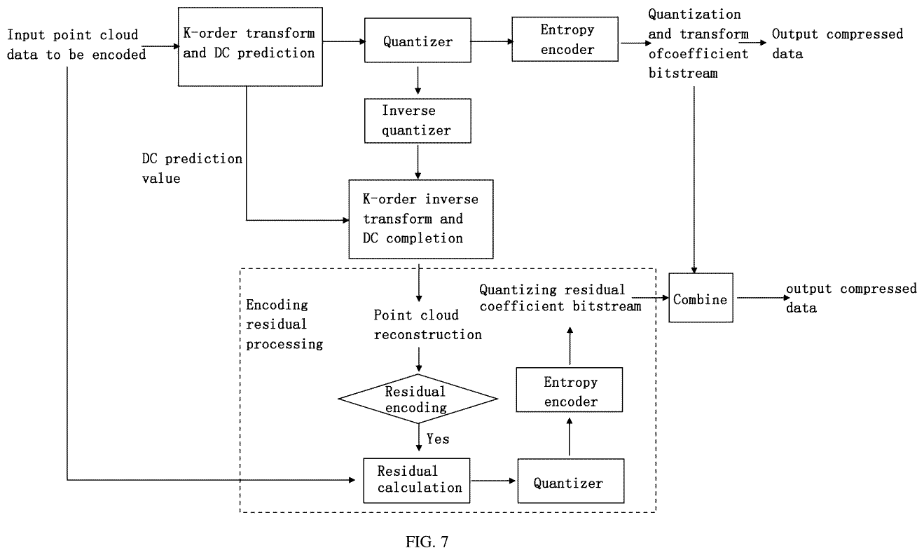

Specifically, the point cloud attribute encoding method may also include an encoding residual processing step, and FIG. 7 is a flowchart of a point cloud attribute encoding method including an encoding residual processing step provided by a non-limiting embodiment or aspect of the present disclosure. As shown in FIG. 7, when carrying out the attribute encoding, the attribute residual values between the reconstructed point cloud and the original point cloud are obtained for each spatial point, and the attribute residual values are then quantized according to the demand to obtain attribute quantization residual coefficients, and finally the attribute quantization residual coefficients are encoded. The reconstructed point cloud is a point cloud with reconstructed attribute values obtained according to the point cloud attribute encoding method, and the original point cloud is an unprocessed point cloud in the point cloud data to be encoded. Specifically, for the limited-lossy condition, quantization encoding is performed for the attribute residual values according to a given quantization step, and control of the Hausdorff error can be realized. For the lossless condition, it can be processed in the following two methods: method 1, for attribute residual values, no quantization is needed, i.e., the quantization step is 1, and the attribute residual values are encoded directly; method 2, for attribute residual values, the attribute quantized residual residues and the attribute quantized residual coefficients are encoded. Among them, for color encoding, the calculation of attribute residual values needs to be performed in the color space of the original point cloud. If the reconstructed point cloud attribute values generated by the inverse transformation are located in a different color space from the attribute values of the original point cloud, for example, the original point cloud has attribute values in the RGB color space and the inverse transformation generates attribute values in the YUV color space, the reconstructed point cloud attribute values generated by the inverse transformation need to be converted in a color space to the same color space as that of the original point cloud before calculation.

Further, the results using the method in non-limiting embodiments or aspects of the present disclosure compared with the benchmark results of the test platform PCRM based on the AVS-PCC PCRM software version v4.0 are shown in Tables 1 and 2 below.

TABLE 1

| limited-lossy geometry, | End-to-end attribute rate distortion | | |
|---|---|---|---|
| lossy attribute | (intra-frame) | | |
| Color data set | Luma | Chroma Cb | Chroma Cr |
| | −16.0% | −51.6% | −56.2% |

| | |
|---|---|
| Reflectance data set | Reflectance |
| | −3.9% |

TABLE 2

| Lossless geometry, | | | |
|---|---|---|---|
| lossy attribute | End-to-end attribute rate distortion (intra-frame) | | |
| Color Data Set | Luma | Chroma Cb | Chroma Cr |
| | −27.3% | −46.7% | −50.5% |

| | |
|---|---|
| Reflectance data set | Reflectance |
| | −3.5% |

Table 1 shows a comparison of the rate distortion results for Luma, Chroma and Reflectance under the conditions of limited lossy geometry and lossy attribute. Table 2 shows a comparison of the rate distortion results for Luma, Chroma and Reflectance under the conditions of lossless geometry and lossy attribute. The results in Tables 1-2 show that compared to the benchmark results of the test platform PCRM, under the conditions of limited lossy geometry and lossy attribute, and of lossless geometry and lossy attribute, the end-to-end attribute rate distortion of the present disclosure is reduced by 16.0% and 27.3% for Luma respectively, by 51.6% and 46.7% for Chroma Cb respectively, by 56.2% and 50.5% for Chroma Cr respectively, and by 3.9% and 3.5% for Reflectance respectively.

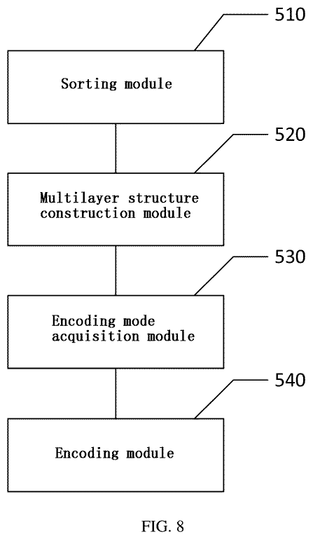

As shown in FIG. 8, corresponding to the point cloud attribute encoding method, non-limiting embodiments or aspects of the present disclosure also provide a point cloud attribute encoding apparatus, which comprises a sorting module 510, a multilayer structure construction module 520, an encoding mode acquisition module 530, and an encoding module 540.

The sorting module 510 is configured for sorting point cloud data to be encoded to obtain sorted point cloud data, wherein the point cloud data to be encoded are point cloud data with attributes to be encoded.

The point cloud data to be encoded are point cloud data with attributes to be encoded. The point cloud encoding mainly includes geometric encoding and attribute encoding, and non-limiting embodiments or aspects of the present disclosure mainly implement point cloud attribute encoding, such as encoding the color attributes of the point cloud.

The multilayer structure construction module 520 is configured for constructing a multilayer structure based on the sorted point cloud data and distances between the sorted point cloud data.

The multilayer structure is a multilayer structure comprising a plurality of nodes, for example, the multilayer structure is an M-layer structure (M is a positive integer), and the Layer m is the bottom layer, then the points corresponding to the point cloud data are treated as the nodes of the Layer m, respectively, and then based on the distances between the nodes of the Layer m, it is determined whether or not it has a parent node and the corresponding parent node is constructed, and so on, layer by layer, the M-layer structure is constructed.

The encoding mode acquisition module 530 is configured for obtaining an encoding mode corresponding to each of nodes in the multilayer structure, wherein the encoding mode corresponding to each of the nodes is a direct encoding mode, a predictive encoding mode, or a transform encoding mode, wherein the predictive encoding mode is to encode a node based on information of a neighboring node corresponding to the node, and wherein the transform encoding mode is to encode the node based on a transform matrix.

The corresponding node may be encoded in the predictive encoding mode based on an existing prediction method, and the corresponding node may be encoded in the transform encoding mode based on a Haar wavelet transform method. In the present disclosure, the corresponding node is encoded in the predictive encoding mode based on an improved prediction method incorporating a multilayer structure, without being specifically limited. The transform matrix is a pre-set transform matrix, which can be set and adjusted according to actual needs, without being specifically limited herein.

The encoding module 540 is configured for encoding point cloud attributes for each of the nodes based on the multilayer structure and the respective encoding mode.

Specifically, based on the multilayer structure and the respective encoding mode, the point cloud attribute data corresponding to each of the nodes are calculated, quantized and entropy encoded to complete the encoding task of the point cloud.

As can be seen from the above, compared with the existing technology, in the solution of the present disclosure, a multilayer structure is constructed based on the distances between sorted point cloud data and encoding is performed based on the multilayer structure, which is conducive to expanding the range of space utilization. Moreover, a suitable encoding mode is assigned to each node to further improve the encoding efficiency of each node, thereby improving the overall encoding efficiency of the point cloud data.

Optionally, the point cloud attribute encoding apparatus may also be provided with an encoding residual processing module (not shown in FIG. 8) for obtaining attribute residual values between the reconstructed point cloud and the original point cloud for each spatial point, then quantizing the attribute residual values to obtain attribute quantization residual coefficients according to the demand, and finally encoding the attribute quantization residual coefficients. That is, the corresponding encoding residual processing step described above is executed, so as to cooperate with the corresponding decoding residual processing to improve the compression accuracy. The specific processing of the encoding residual processing module may refer to the corresponding description in the encoding residual processing step, and will not be repeated herein.

It is to be noted that the specific functions or settings of the point cloud attribute encoding apparatus and its modules may refer to the non-limiting embodiments or aspects of the method described above and will not be repeated herein.

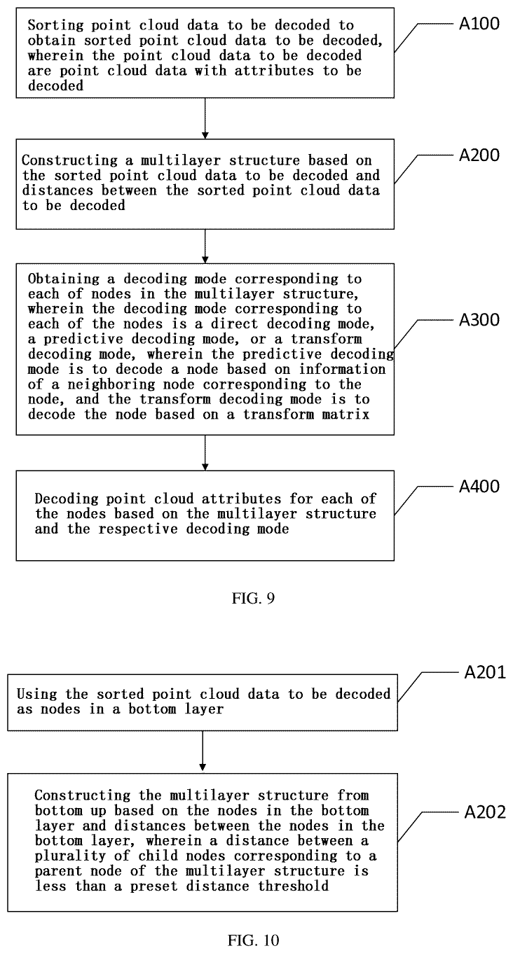

As shown in FIG. 9, corresponding to the point cloud attribute encoding method, non-limiting embodiments or aspects of the present disclosure further provide a point cloud attribute decoding method, which comprises the following steps.

At step A100, point cloud data to be decoded are sorted to obtain sorted point cloud data to be decoded, wherein the point cloud data to be decoded are point cloud data with attributes to be decoded.

The point cloud data to be decoded are point cloud data with attributes to be decoded. Specifically, they are the point cloud data encoded based on the point cloud attribute encoding method provided in the non-limiting embodiments or aspects of the present disclosure.

At step A200, a multilayer structure is constructed based on the sorted point cloud data to be decoded and distances between the sorted point cloud data to be decoded.

The multilayer structure is a multilayer structure comprising a plurality of nodes, for example, the multilayer structure is an M-layer structure (M is a positive integer), and the Layer m is the bottom layer, then the points corresponding to the point cloud data are taken as the nodes of the Layer m, respectively, and then based on the distances between the nodes of the Layer m, it is determined whether or not it has a parent node and the corresponding parent node is constructed, and so on, layer by layer, to construct the M-layer structure. The specific M-layer structure and the method of constructing the M-layer structure are similar to the encoding process and will not be repeated here.

At step A300, a decoding mode corresponding to each of nodes in the multilayer structure is obtained, wherein the decoding mode corresponding to each node is a direct decoding mode, a predictive decoding mode, or a transform decoding mode, wherein the predictive decoding mode is to decode a node based on information of a neighboring node corresponding to the node, and the transform decoding mode is to decode the node based on a transform matrix.

The corresponding node may be decoded in the predictive decoding mode based on an existing prediction method, and the corresponding node may be decoded in the transform decoding mode based on a Haar wavelet transform method. In the present disclosure, the corresponding node is decoded in the predictive decoding mode based on an improved prediction method incorporating a multilayer structure, without being specifically limited. The transform matrix is the same as the transform matrix used in the decoding process.

At step A400, point cloud attributes are encoded for each of the nodes based on the multilayer structure and corresponding decoding mode respectively.

Specifically, based on the multilayer structure and the corresponding decoding mode, the point cloud attribute data corresponding to each of the nodes are calculated, entropy decoded, and inversely quantized, to complete the decoding task of the point cloud.

In this way, decoding of the encoded data can be realized, which is conducive to expanding the range of space utilization. Moreover, a suitable decoding mode is assigned to each node to further improve the decoding efficiency of each node, thereby improving the overall decoding efficiency of the point cloud data.

Specifically, in this non-limiting embodiment or aspect, the step A200 comprises: based on three-dimensional coordinates of each of the point cloud data to be decoded, arranging the point cloud data to be decoded into a one-dimensional order from a three-dimensional distribution according to a preset rule to obtain the sorted point cloud data to be decoded. The preset rule is pre-set sorting rule, which may be set and adjusted according to actual needs. Optionally, the preset rule may be a sorting rule based on a Morton code or a Hilbert code.

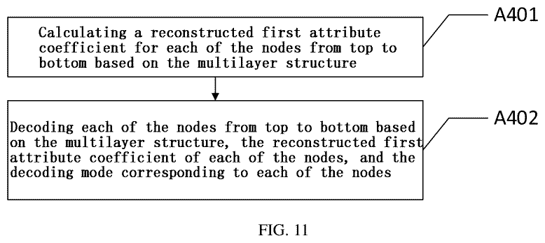

Specifically, in this non-limiting embodiment or aspect, as shown in FIG. 10, the step A200 comprises the following steps.

At step A201, all the sorted point cloud data to be decoded are used as nodes in a bottom layer.

At step A202, the multilayer structure is constructed from bottom up based on the nodes in the bottom layer and distances between the nodes in the bottom layer, wherein a distance between a plurality of child nodes corresponding to a parent node in the multilayer structure is less than a preset distance threshold.

The specific process of constructing the multilayer structure may refer to the corresponding description in the encoding process and will not be repeated here.

Specifically, in this non-limiting embodiment or aspect, as shown in FIG. 11, the step A400 comprises the following steps.

At step A401, a reconstructed first attribute coefficient for each of the nodes is calculated from top to bottom based on the multilayer structure.

At step A402, each node is decoded from top to bottom based on the multilayer structure, the reconstructed first attribute coefficient of each node, and the decoding mode corresponding to each node.

Specifically, the reconstructed first attribute coefficient of each node is calculated from top to bottom based on the M-layer structure in the following steps.
a. The jth node in the first layer is decoded directly, to obtain the reconstructed first attribute coefficient by entropy decoding and inverse quantization from the bitstream. The reconstructed first attribute coefficient obtained here is identical to the reconstructed first attribute coefficient obtained during encoding process.
b. The reconstructed first attribute coefficient b1′ of the jth node in the layer m is obtained, and the reconstructed second attribute coefficient b2′ is obtained by entropy decoding and inverse quantization from the bitstream. The reconstructed first attribute coefficients a1′ and a2′ of the jth node corresponding to the two transform decoding mode child nodes are obtained by inversely transforming b1′ and b2′. In this way, all nodes in the m-layer are traversed.
c. For the jth predictive decoding mode node in the layer m+1, if it has no parent node, then its K nearest nodes within the layer that have already calculated the reconstructed first attribute coefficients are searched for, and their reconstructed first attribute coefficients are used to compute the first attribute prediction value of the jth node. The reconstruction attribute residual coefficient is obtained from the bitstream by entropy decoding and inverse quantization, which is added with the first attribute prediction value of the node j to obtain the reconstructed first attribute coefficient of the node j. In this way, the nodes in the layer m+1 are traversed and calculated.

Each layer of the M-layer structure for m=1, 2, . . . , M−2, M−1 is traversed from top to bottom, and the relevant calculations in the steps b and c are performed iteratively.

Similar to the encoding process, referring to FIG. 4, the step a is performed for the nodes in the first layer in FIG. 4 which use a direct decoding mode. The step b is performed for all nodes in the first layer, and the child nodes of the nodes in the first layers use a transform decoding mode. The step c is performed for the nodes in the second layer without a parent node, which use a predictive decoding mode. The step b is performed for all nodes in the second layer, and the child nodes of the nodes use a transform decoding mode. The step c is performed for the nodes in the third layer without a parent node, which use a predictive decoding mode. This process is repeated until the step b is performed for nodes in the layer M−1 and the step c is performed for nodes in the layer M without a parent node.

After completing the calculations for layers, the reconstructed first attribute coefficients of the N nodes of the Layer m are obtained as the reconstructed attribute values of the point cloud, so that the reconstructed point cloud is obtained, and the decoding is finished. The purpose of decoding is to obtain the reconstructed first attribute coefficients of N nodes as the reconstructed attribute values of the point cloud, and the reconstructed attribute values=original attribute values+error.

Optionally, in this non-limiting embodiment or aspect, the point cloud attribute decoding method may also refer to the specific steps in the point cloud attribute encoding method to carry out the corresponding decoding, for example, to carry out the inverse quantization based on the corresponding quantization step in the point cloud attribute encoding method, etc., which will not be repeated herein. In this way, decoding of the data encoded based on the point cloud attribute encoding method can be realized.

Further, in order to reduce the loss in the attribute encoding and decoding process, and to realize lossless or limited lossy attribute encoding and decoding, corresponding to the encoding residual processing step described above, a decoding residual processing step may be provided to improve the accuracy in the encoding and decoding process.

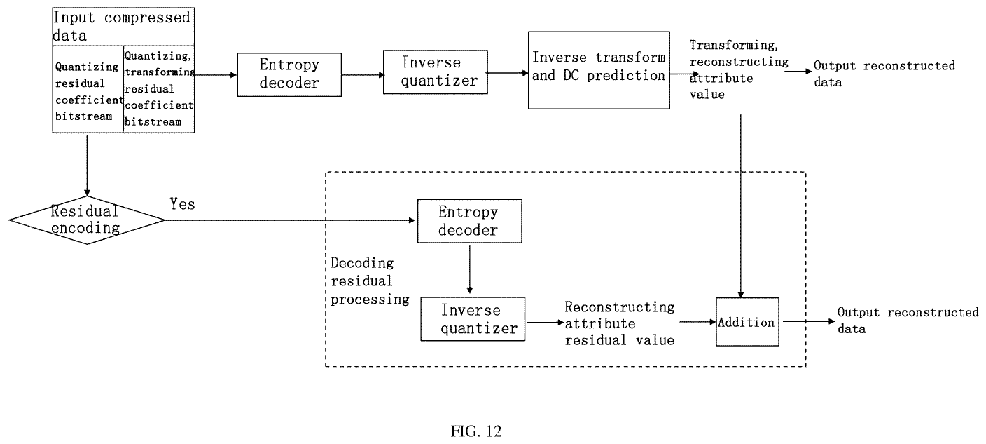

Specifically, the point cloud attribute decoding method may also include a decoding residual processing step, and FIG. 12 is a flowchart of a point cloud attribute decoding method including a decoding residual processing step provided by a non-limiting embodiment or aspect of the present disclosure. As shown in FIG. 12, when attribute decoding is carried out, a reconstructed point cloud and a quantized residual coefficient bitstream are input into a decoding residual processing module as input data. Within the module, entropy decoding is first performed on the quantized residual coefficient bitstream to obtain quantized attribute residual coefficients. Next, inverse quantization is performed on the quantized attribute residual coefficients to obtain reconstructed attribute residual values, and finally, the reconstructed attribute residual values are added with the reconstructed attribute values of the point cloud to finally obtain the decoded point cloud attributes. Specifically, for the limited-lossy condition, for the quantized residual coefficient bitstream, entropy decoding is first performed to obtain the quantized attribute residual coefficients, and then inverse quantization is performed according to a given quantization step (the same as the quantization step in the encoding residual processing step) to obtain the attribute residual values. For the lossless condition, it can be processed by the following two methods: method 1, for the existing attribute residual value bitstream, firstly, entropy decoding is performed to obtain the attribute residual values, and the inverse quantization processing is not necessary, and the attribute residual values are directly added with the reconstructed point cloud attribute values to obtain the final decoding result of the point cloud attribute; method 2, for the existing attribute quantized residual residue stream and attribute quantized residual coefficient stream. Firstly, entropy decoding is carried out to obtain the attribute quantized residual residue and the attribute quantized residual coefficient, then inverse quantization is carried out to obtain the reconstructed attribute residual residue and the reconstructed attribute residual coefficient, and finally the reconstructed attribute residual residue, the reconstructed attribute residual coefficient, and the reconstructed point cloud attribute value are added to finally obtain the decoded point cloud attributes. Among them, for color decoding, the decoding residual processing needs to be performed in the color space of the original point cloud. If the reconstructed point cloud attribute values generated by decoding are located in a different color space from the attribute values of the original point cloud, for example, the original point cloud has attribute values in the RGB color space, while the decoded point cloud has attribute values in the YUV color space, the reconstructed point cloud attribute values generated by the inverse transformation needs to be converted in a color space to the same color space as that of the original point cloud before calculation.

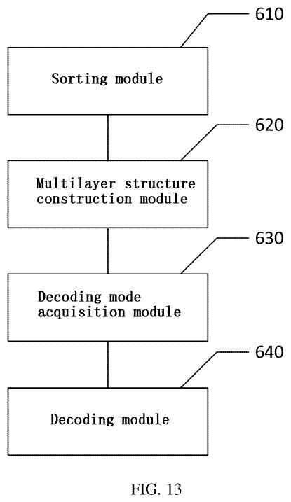

As shown in FIG. 13, corresponding to the point cloud attribute decoding method, non-limiting embodiments or aspects of the present disclosure also provide a point cloud attribute decoding apparatus, the point cloud attribute decoding apparatus comprises a sorting module 610, a multilayer structure construction module 620, a decoding mode acquisition module 630, and a decoding module 640.

The sorting module 610 is configured for sorting point cloud data to be decoded to obtain sorted point cloud data to be decoded, wherein the point cloud data to be decoded are point cloud data with attributes to be decoded.

The point cloud data to be decoded are point cloud data with attributes to be decoded. Specifically, they are the point cloud data encoded based on the point cloud attribute encoding method provided in the non-limiting embodiments or aspects of the present disclosure.

The multilayer structure construction module 620 is configured for constructing a multilayer structure based on the sorted point cloud data to be decoded and distances between the sorted point cloud data to be decoded.

The multilayer structure is a multilayer structure comprising a plurality of nodes, for example, the multilayer structure is an M-layer structure (M is a positive integer), and the Layer m is the bottom layer, then the points corresponding to the point cloud data are taken as the nodes of the Layer m, respectively, and then based on the distances between the nodes of the Layer m, it is determined whether or not it has a parent node and the corresponding parent node is constructed, and so on, layer by layer, to construct the M-layer structure. The specific M-layer structure and the method of constructing the M-layer structure are similar to the encoding process and will not be repeated here.

The decoding mode acquisition module 630 is configured for obtaining a decoding mode corresponding to each of nodes in the multilayer structure, wherein a decoding mode corresponding to each node is a direct decoding mode, a predictive decoding mode, or a transform decoding mode, wherein the predictive decoding mode is to decode a node based on information of a neighboring node corresponding to the node, and the transform decoding mode is to decode the node based on a transform matrix.

The corresponding node may be decoded in the predictive decoding mode based on an existing prediction method, and the corresponding node may be decoded in the transform decoding mode based on a Haar wavelet transform method. In the present disclosure, the corresponding node is decoded in the predictive decoding mode based on an improved prediction method incorporating a multilayer structure, without being specifically limited. The transform matrix is the same as the transform matrix used in the encoding process.

The decoding module 640 is configured for decoding point cloud attributes for each of the nodes based on the multilayer structure and corresponding decoding mode respectively.

Specifically, based on the multilayer structure and the corresponding decoding mode, the point cloud attribute data corresponding to each of the nodes are calculated, entropy decoded, and inversely quantized, to complete the decoding task of the point cloud.

In this way, decoding of the encoded data can be realized, which is conducive to expanding the range of space utilization. Moreover, a suitable decoding mode is assigned to each node to further improve the decoding efficiency of each node, thereby improving the overall decoding efficiency of the point cloud data.

Optionally, the point cloud attribute decoding apparatus may also be provided with a decoding residual processing module (not shown in FIG. 13) for obtaining attribute residual values between the reconstructed point cloud and the original point cloud for each spatial point, then quantizing the attribute residual values to obtain attribute quantization residual coefficients according to the demand, and finally decoding the attribute quantization residual coefficients. That is, the corresponding decoding residual processing step described above is executed, so as to cooperate with the corresponding decoding residual processing to improve the compression accuracy. The specific processing of the decoding residual processing module may refer to the corresponding description in the decoding residual processing step, and will not be repeated herein.

It is to be noted that the specific functions or settings of the point cloud attribute decoding apparatus and its modules may refer to the non-limiting embodiments or aspects of the method described above and will not be repeated herein.

Based on the above non-limiting embodiments or aspects, the present disclosure also provides an intelligent terminal. The intelligent terminal includes a processor, a memory, a network interface, and a display, which are connected via a system bus. The processor of the intelligent terminal is used to provide computing and control capabilities. The memory of the intelligent terminal includes a non-volatile storage medium, an internal memory. The non-volatile storage medium stores an operating system and a point cloud attribute encoding program and/or a point cloud attribute decoding program. The internal memory provides an environment for the operation of the operating system and the point cloud attribute encoding program and/or the point cloud attribute decoding program in the non-volatile storage medium. The network interface of the intelligent terminal is used for communicating with an external terminal via a network connection. The point cloud attribute encoding program and/or the point cloud attribute decoding program, when executed by the processor, implements the steps of any of the point cloud attribute encoding and/or decoding methods. The display of the intelligent terminal may be a liquid crystal display or an electronic ink display.

Non-limiting embodiments or aspects of the present disclosure also provide a computer-readable storage medium, the computer-readable storage medium having stored thereon a point cloud attribute encoding program and/or a point cloud attribute decoding program, the point cloud attribute encoding program and/or point cloud attribute decoding program being executed by a processor to realize the steps of any one of the point cloud attribute encoding and/or decoding methods provided by non-limiting embodiments or aspects of the present disclosure.

It should be understood that the sequence number of each step in the above non-limiting embodiments or aspects does not mean the order of execution. The order of execution of each process should be determined by its function and internal logic, and should not constitute any limitation on the implementation process of the non-limiting embodiments or aspects of this disclosure.

Those of ordinary skills in the art t can clearly understand that the above functional units and modules are divided for the sake of convenience and conciseness. In actual applications, the above functions can be assigned to different functional units and modules according to needs, that is, the internal structure of the above apparatus can be divided into different functional units or modules to complete or part of the functions described above. The functional units and modules in the non-limiting embodiments or aspects can be integrated in one processing unit, or can be physically present separately, or two or more units can be integrated in one unit. The integrated unit can be implemented in either hardware or software. In addition, the specific names of the functional units and modules are only for the convenience of distinguishing them, and are not used to limit the scope of protection of the present disclosure. The specific working processes of the units and modules in the above system may refer to the corresponding processes in the non-limiting embodiments or aspects of the above methods, and will not be repeated herein.

In the above non-limiting embodiments or aspects, the description of each embodiment has its own focus, and portions of a non-limiting embodiment or aspect that are not detailed or documented can be found in the relevant descriptions of other non-limiting embodiments or aspects.

Those of ordinary skills in the art may realize that the units and algorithmic steps of the various examples described in conjunction with the non-limiting embodiments or aspects disclosed herein are capable of being implemented in electronic hardware, firmware or a combination of computer software and electronic hardware. Whether these functions are performed in hardware or software depends on the particular application and design constraints of the technical solution. Those of ordinary skills in the art may use different methods to implement the described functions for each particular application, but such implementations should not be considered beyond the scope of the present disclosure.

In the non-limiting embodiments or aspects provided in the present disclosure, it should be understood that the disclosed apparatus/terminal device and method, may be realized in other ways. For example, the apparatus/terminal device non-limiting embodiments or aspects described above are merely schematic, e.g., the division of modules or units described above is merely a logical functional division, and may be realized in practice by another division, e.g., a plurality of units or components may be combined or may be integrated into another system, or some features may be ignored, or not implemented.

The integrated module/unit may be stored in a computer-readable storage medium if it is realized in the form of a software functional unit and sold or used as a stand-alone product. Based on this understanding, or part of the processes for implementing the method in the non-limiting embodiments or aspects of the present disclosure may also be accomplished by instructing the relevant hardware by means of a computer program, and the computer program may be stored in a computer-readable storage medium which, when executed by a processor, implements the steps of each of the non-limiting embodiments or aspects of the method of the present disclosure. The computer program comprises computer program code, the computer program code may be in the form of source code, in the form of object code, in the form of an executable file, or in some intermediate form, and the like. The computer-readable medium can include any entity or device that can carry the above computer program code, such as a recording medium, USB drive, external hard drive, disk, optical disc, computer storage, read-only memory (ROM), random access memory (RAM), electromagnetic carrier signal, telecommunications signal, and software distribution medium. It should be noted that the content of the above computer-readable storage medium can be appropriately increased or decreased according to the requirements of legislation and patent practice within the jurisdiction.

The above non-limiting embodiments or aspects are only used to illustrate the technical solutions of the present disclosure, not to limit them. Although the present disclosure has been described in detail with reference to the foregoing non-limiting embodiments or aspects, those of ordinary skills in the art should understand that it is still possible to make modifications to the technical solutions documented in the foregoing non-limiting embodiments or aspects or to make equivalent replacements for some of the technical features therein, and these modifications or replacements are not the essence of the corresponding technical solutions. These modifications or replacements, which do not cause the essence of the corresponding technical solutions to be deviated from the spirit and scope of the technical solutions of the non-limiting embodiments or aspects of the present disclosure, should all fall within the scope of protection of the present disclosure.

1. A point cloud attribute encoding method, comprising:
sorting point cloud data to be encoded to obtain sorted point cloud data, wherein the point cloud data to be encoded are point cloud data with attributes to be encoded;
constructing a multilayer structure based on the sorted point cloud data and distances between the sorted point cloud data;
obtaining an encoding mode corresponding to each of nodes in the multilayer structure, wherein the encoding mode corresponding to each of the nodes is a direct encoding mode, a predictive encoding mode, or a transform encoding mode, wherein the predictive encoding mode is to encode a node based on information of a neighboring node corresponding to the node, and wherein the transform encoding mode is to encode the node based on a transform matrix; and
encoding point cloud attributes for each of the nodes based on the multilayer structure and the respective encoding mode.

2. The point cloud attribute encoding method according to claim 1, wherein the sorting point cloud data to be encoded to obtain sorted point cloud data comprises:
based on three-dimensional coordinates of each of the point cloud data to be encoded, arranging the point cloud data to be encoded into a one-dimensional order from a three-dimensional distribution according to a preset rule to obtain the sorted point cloud data.

3. The point cloud attribute encoding method according to claim 1, wherein the constructing a multilayer structure based on the sorted point cloud data and distances between the sorted point cloud data comprises:
using the sorted point cloud data as nodes in a bottom layer; and
constructing the multilayer structure from bottom up based on the nodes in the bottom layer and distances between the nodes in the bottom layer, wherein a distance between a plurality of child nodes corresponding to a parent node of the multilayer structure is less than a preset distance threshold.

4. The point cloud attribute encoding method according to claim 1, wherein the obtaining an encoding mode corresponding to each of nodes in the multilayer structure, wherein the encoding mode corresponding to each of the nodes is a direct encoding mode, a predictive encoding mode, or a transform encoding mode, comprises:
setting the encoding mode corresponding to direct encoding nodes in the multilayer structure to be the direct encoding mode, the direct encoding nodes being nodes in the first layer of the multilayer structure;
setting the encoding mode corresponding to predictive encoding nodes in the multilayer structure to be the predictive encoding mode, the predictive encoding nodes being nodes from a second layer to a layer m of the multilayer structure that do not have a parent node; and
setting the encoding method corresponding to transform encoding nodes in the multilayer structure to be the transform encoding mode, the transform encoding nodes being nodes from the second layer to the layer m of the multilayer structure that have a parent node;
wherein the multilayer structure comprises M layers, the layer m is a bottom layer.

5. The point cloud attribute encoding method according to claim 4, wherein the direct encoding mode is to encode the direct encoding nodes directly based on information of the direct encoding nodes; the predictive encoding mode is to encode the predictive encoding nodes based on information of neighboring nodes within a proximity range of the respective predictive encoding nodes; and the transform encoding mode is to encode the transform encoding nodes using a transform matrix.

6. The point cloud attribute encoding method according to claim 5, wherein the encoding point cloud attributes for each of the nodes based on the multilayer structure and the respective encoding mode comprises:
calculating a first attribute coefficient of each of the nodes based on the multilayer structure from bottom up, wherein the first attribute coefficient of a node in the bottom layer of the multilayer structure is a raw point cloud attribute value corresponding to the node, and the first attribute coefficients of nodes in other layers are DC coefficients corresponding to the respective nodes in the other layers; and
encoding each of the nodes from top to bottom based on the multilayer structure, the first attribute coefficient of each of the nodes, and the respective encoding mode of each of the nodes.

7. The point cloud attribute encoding method according to claim 6, wherein the encoding each of the nodes from top to bottom based on the multilayer structure, the first attribute coefficient of each of the nodes, and the respective encoding mode of each of the nodes comprises:
traversing the multilayer structure from top to bottom from m=1 to m=M−1, to obtain second attribute coefficient and/or first attribute residual coefficient corresponding to each of the nodes by:
taking nodes in a layer m as first target nodes, calculating the second attribute coefficients for each of the first target nodes and reconstructed first attribute coefficients of transform encoding mode child nodes of each of the first target nodes based on each of the first target nodes and the respective transform encoding mode child nodes; and
for each of predictive encoding nodes in a layer m+1, obtaining a second target node corresponding to each of the predictive encoding nodes in the layer m+1 respectively, and obtaining by estimation the first attribute residual coefficients of the corresponding predictive encoding nodes;
wherein the second attribute coefficient is an AC coefficient corresponding to each of the nodes, the second target node comprises K nodes in the layer m+1 that are closest to the respective predictive encoding node and have calculated the reconstructed first attribute coefficients, and K is a preset number of searches; and
performing quantization and entropy encoding for the first attribute coefficients of the nodes in the first layer of the multilayer structure and the second attribute coefficients and/or the first attribute residual coefficients of the nodes in the other layers.

8. (canceled)

9. A point cloud attribute decoding method, comprising:
sorting point cloud data to be decoded to obtain sorted point cloud data to be decoded, the point cloud data to be decoded being point cloud data with attributes to be decoded;
constructing a multilayer structure based on the sorted point cloud data to be decoded and distances between the sorted point cloud data to be decoded;
obtaining a decoding mode corresponding to each of nodes in the multilayer structure, wherein the decoding mode corresponding to each of the nodes is a direct decoding mode, a predictive decoding mode, or a transform decoding mode, wherein the predictive decoding mode is to decode a node based on information of a neighboring node corresponding to the node, and the transform decoding mode is to decode the node based on a transform matrix; an
decoding point cloud attributes for each of the nodes based on the multilayer structure and the respective decoding mode.

10. The point cloud attribute decoding method according to claim 9, wherein the sorting point cloud data to be decoded to obtain sorted point cloud data to be decoded, the point cloud data to be decoded being point cloud data with attributes to be decoded, comprises:
based on three-dimensional coordinates of each of the point cloud data to be decoded, arranging the point cloud data to be decoded into a one-dimensional order from a three-dimensional distribution according to a preset rule, to obtain the sorted point cloud data to be decoded.

11. The point cloud attribute decoding method according to claim 9, wherein the constructing a multilayer structure based on the sorted point cloud data to be decoded and distances between the sorted point cloud data to be decoded comprises:
using the sorted point cloud data to be decoded as nodes in a bottom layer; and
constructing the multilayer structure from bottom up based on the nodes in the bottom layer and distances between the nodes in the bottom layer, wherein a distance between a plurality of child nodes corresponding to a parent node of the multilayer structure is less than a preset distance threshold.

12. The point cloud attribute decoding method according to claim 9, wherein the decoding point cloud attributes for each of the nodes based on the multilayer structure and the respective decoding mode comprises:
calculating a reconstructed first attribute coefficient for each of the nodes from top to bottom based on the multilayer structure; and
decoding each of the nodes from top to bottom based on the multilayer structure, the reconstructed first attribute coefficient of each of the nodes, and the decoding mode corresponding to each of the nodes.

13. A point cloud attribute decoding apparatus, comprising:
a sorting module for sorting point cloud data to be decoded to obtain sorted point cloud data to be decoded, wherein the point cloud data to be decoded are point cloud data with attributes to be decoded;
a multilayer structure construction module for constructing a multilayer structure based on the sorted point cloud data to be decoded and distances between the sorted point cloud data to be decoded;
a decoding mode acquisition module for acquiring a decoding mode corresponding to each of nodes in the multilayer structure, wherein the decoding mode corresponding to each of the nodes is a direct decoding mode, a predictive decoding mode, or a transform decoding mode, wherein the predictive decoding mode is to decode a node based on information of a neighboring node corresponding to the node, and the transform decoding mode is to decode the node based on a transform matrix; and
a decoding module for decoding point cloud attributes for each of the nodes based on the multilayer structure and the respective decoding mode.

14. The point cloud attribute decoding method according to claim 9, wherein the obtaining a decoding mode corresponding to each of nodes in the multilayer structure, wherein the decoding mode corresponding to each of the nodes is a direct decoding mode, a predictive decoding mode, or a transform decoding mode, comprises:
setting the decoding mode corresponding to direct decoding nodes in the multilayer structure to be the direct decoding mode, the direct decoding nodes being nodes in the first layer of the multilayer structure;
setting the decoding mode corresponding to predictive decoding nodes in the multilayer structure to be the predictive decoding mode, the predictive decoding nodes being nodes from a second layer to a layer m of the multilayer structure that do not have a parent node; and
setting the decoding method corresponding to transform decoding nodes in the multilayer structure to be the transform decoding mode, the transform decoding nodes being nodes from the second layer to the layer m of the multilayer structure that have a parent node;
wherein the multilayer structure comprises M layers, the layer m is a bottom layer.

15. The point cloud attribute decoding method according to claim 14, wherein the direct decoding mode is to encode the direct decoding nodes directly based on information of the direct decoding nodes; the predictive decoding mode is to encode the predictive decoding nodes based on information of neighboring nodes within a proximity range of the respective predictive decoding nodes; and the transform decoding mode is to encode the transform decoding nodes using a transform matrix.

16. The point cloud attribute decoding method according to claim 15, wherein the decoding point cloud attributes for each of the nodes based on the multilayer structure and the respective decoding mode comprises:
obtaining, and performing entropy decoding and inverse quantization on a bitstream to be decoded, to obtain reconstructed first attribute coefficients of the nodes in the first layer of the multilayer structure and reconstructed second attribute coefficients and/or reconstructed first attribute residual values of each of the nodes; and
decoding each of the nodes from top to bottom based on the multilayer structure, the reconstructed first attribute coefficients and the reconstructed second attribute coefficients and/or the reconstructed first attribute residual values of each of the nodes, and the respective decoding mode of each of the nodes.

17. The point cloud attribute decoding method according to claim 14, wherein the decoding each of the nodes from top to bottom based on the multilayer structure, the reconstructed first attribute coefficients and the reconstructed second attribute coefficients and/or the reconstructed first attribute residual values of each of the nodes, and the respective decoding mode of each of the nodes, comprises:
traversing the multilayer structure from top to bottom from m=1 to m=M−1, to obtain the reconstructed first attribute coefficients corresponding to each of the nodes by:
taking the transform decoding nodes in the layer m as first target nodes, obtaining by calculation the reconstructed first attribute coefficients of child nodes of each of the first target nodes based on the reconstructed first attribute coefficients and the reconstructed second attribute coefficients of each of the first target nodes; and
for each of the predictive decoding nodes in a layer m+1, obtaining a second target node corresponding to each of the predictive decoding nodes in the layer m+1, respectively, obtaining by estimation a first attribute prediction value of each of the predictive decoding nodes based on a reconstructed first attribute coefficient of the second target node, and taking a sum of the first attribute prediction value and the reconstructed first attribute residual value of each of the predictive decoding nodes as the reconstructed first attribute coefficient of each of the predictive decoding nodes;
wherein the reconstructed second attribute coefficient is a reconstructed AC coefficient corresponding to the decoding node, the second target node is one of K nodes in the layer m+1 that are closest to the respective predicted encoding node and have calculated the reconstructed first attribute coefficients, and K is a preset number of searches.
